(19) United States
(12) Patent Application Publication
(10) Pub. No.: US 2008/0180315 A1
(43) Pub. Date: Jul. 31, 2008

(54) Methods and systems for position estimation using satellite signals over multiple receive signal instances

(75) Inventors: Ben Tarlow, Walthamstow (GB); Stuart Strickland, Bishop's Stortford (GB)

Correspondence Address: Ralph A. Dowell of DOWELL & DOWELL P.C., 2111 Eisenhower Ave, Suite 406, Alexandria, VA, 22314, US

(73) Assignee: SIGE SEMICONDUCTOR (EUROPE) LIMITED

(21) Appl. No.: 11/698,197

(22) Filed: Jan. 26, 2007

(51) Int. Cl. G01S 5/14

(52) U.S. Cl. 342/357.01; 342/357.06

(57) ABSTRACT

Methods and devices are provided for receiving satellite positioning information at least two different instances from at least one satellite during each respective different instance and calculating a position estimate using received information from the at least two different instances. In some embodiments the invention enables estimation of a position by collecting data from several sets of satellite position signal measurements where an individual set of these measurements may be insufficient to generate an instantaneous position fix. In some embodiments the invention enables the treatment of measurements made of signals from the same satellite, but at different times, as being coincident but originating from satellites in different positions. In some embodiments the invention enables the estimation of a position from measurement signals received in possibly different places, with estimated and/or known relative offsets. In some embodiments the invention enables the use of integrated inertial-sensing equipment to assist a satellite navigation receiver by supplying relative position and velocity data.

### FIELD OF THE INVENTION

The invention relates to determining position estimates based on satellite-based positioning information.

### BACKGROUND OF THE INVENTION

The basic functionality of a Global Positioning System (GPS) receiver is determining its position by computing time delays between transmission and reception of signals transmitted from a network of GPS satellites that orbit the earth, which are received by the receiver on or near the surface of the earth. The GPS satellites transmit to the receiver absolute time information associated with the satellite signal. A respective time delay resulting from signal transmission from each of the respective satellites to the receiver is multiplied by the speed of light to determine the distance from the receiver to each of the respective satellites from which data is received. The GPS satellites also transmit to the receivers satellite-positioning data, generally known as ephemeris data.

The absolute time signal allows the receiver to determine a time tag for when each received signal was transmitted by each respective satellite. By knowing the exact time of transmission of each of the signals, the receiver uses the ephemeris data to calculate where each satellite was when it transmitted a signal. The receiver then combines the knowledge of respective satellite positions with the computed distances to the satellites to compute the receiver's position.

Position calculations generated from satellite signals require pseudorange measurements, ephemeris data, and absolute time of transmission, from four satellites or more to determine a three dimensional position estimate of the GPS receiver's location, which includes latitude, longitude and altitude. Measurement information from three satellites is needed to determine a two dimensional position estimate of the GPS receiver's location, which includes latitude and longitude.

In poor signal environments, for example indoors or in dense urban areas, there may be prolonged periods for which fewer than three satellites are visible to the receiver. In these situations, receivers cannot generate an instantaneous position estimate or “fix”. Even when a position estimate is derived with signals from three or more satellites, which enables at least a two dimensional position estimate, the effects of signal multipath and false signal detection may lead to the position estimate having a large error. Multipath or other forms of interference may affect signals received from several satellites differently so that a subset of the received signals are responsible for introducing error in the position estimate.

### SUMMARY OF THE INVENTION

According to a first aspect of the invention there is provided a method comprising: receiving satellite positioning information at least two different instances from at least one satellite during each respective different instance; and calculating a position estimate using the received information at the at least two different instances.

In some embodiments, receiving satellite positioning information at least two different instances from at least one satellite during each respective different instances comprises receiving satellite positioning information at least two different instances from more than one satellite during each respective different instance.

In some embodiments, receiving satellite positioning information at least two different instances from at least one satellite during each respective different instance comprises receiving satellite positioning information at least three different instances from a single satellite at each respective different time.

In some embodiments, the single satellite is a different single satellite at one or more of the at least two different instances.

In some embodiments, the single satellite is the same single satellite at each of the at least two different instances.

In some embodiments, receiving satellite positioning information at least two different instances from at least one satellite during each respective different instance comprises receiving satellite positioning information at more than two different instances from at least one satellite.

In some embodiments, calculating a position estimate using the received information at the at least two different instances further comprises determining a duration between a current instance of receiving satellite positioning information and a previous instance of receiving satellite positioning information.

In some embodiments, calculating a position estimate using the received information at the at least two different instances comprises calculating a two dimensional position estimate including longitude and latitude.

In some embodiments, calculating a position estimate using the received information at the at least two different instances comprises calculating a three dimensional position estimate including longitude, latitude and altitude.

In some embodiments, calculating a position estimate using the received information at the at least two different instances comprises: receiving satellite positioning information from three satellites at one instance; calculating a two dimensional position estimate; and using satellite positioning information from a satellite at a different instance to augment the two dimensional position estimate to a three dimensional position estimate.

In some embodiments, calculating a position estimate using the received information at the at least two different instances comprises: receiving satellite positioning information from at least four satellites at one instance; calculating a three dimensional position estimate; and using satellite positioning information from a satellite at a different instance to augment the three dimensional position estimate.

In some embodiments, the method further comprises determining a relative change in position between different instances of receiving satellite positioning information using data from inertial sensors.

In some embodiments, using data from inertial sensors comprises using data from one or more of: a compass; an accelerometer; a speedometer; and a pedometer.

In some embodiments, the method further comprises selecting a duration between instances that satellite positioning information is received.

In some embodiments, receiving satellite positioning information at least two different instances from at least one satellite comprises receiving satellite positioning information from at least one satellite, the at least one satellite being any one of: a satellite of the Global Positioning Satellite (GPS) network, a satellite of the Galileo satellite network, a satellite of the Global Navaigation Satellite System (GLONASS) network, a Wide Area Augmentation System (WAAS) enabled satellite and a European Geostationary Navigation Overlay Service (EGNOS) enabled satellite.

In some embodiments, a previously estimated position estimate is used in combination with received information from the at least two different instances for calculating a current position estimate.

According to a second aspect of the invention there is provided a receiver for receiving satellite positioning information comprising: an antenna for receiving satellite positioning information at least two different instances from at least one satellite during each respective different instance; position estimation logic for calculating a position estimate using the received information at the at least two different instances.

In some embodiments, the method further comprises an integrated inertial sensor.

In some embodiments, adapted to receive inertial sensor information generated external to, but collocated with the receiver for determining a relative change in position between different instances of receiving satellite positioning information using data from inertial sensors.

In some embodiments, the integrated inertial sensor comprises one or more of a group consisting of: a compass; an accelerometer; a speedometer; and a pedometer.

In some embodiments the invention enables estimation of a position by collecting data from several sets of satellite position signal measurements where an individual set of these measurements may be insufficient to generate an instantaneous position fix.

In some embodiments the invention enables the treatment of measurements made of signals from the same satellite, but at different times, as being coincident but originating from satellites in different positions.

In some embodiments the invention enables the estimation of a position from measurement signals received in possibly different places, with estimated and/or known relative position offsets. Signals received in different places will also necessarily be received at different times. In such cases, the elapsed time between measurements as well as the relative position offset are determined when estimating the position.

In some embodiments the invention enables the use of integrated inertial-sensing equipment to assist a satellite navigation receiver by supplying relative position and velocity data.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the invention will now be described with reference to the attached drawings in which:

FIG. 1 is a flow chart for a method of determining a position estimate using satellite positioning information according to an embodiment of the invention;

FIG. 2 is a flow chart for a method of determining a position estimate using satellite positioning information according to another embodiment of the invention; and

FIG. 3 is a block diagram of a receiver for receiving satellite positioning signals and calculating a position estimate for the receiver.

### DETAILED DESCRIPTION OF THE EMBODIMENTS OF THE INVENTION

Typically, measurement information from three or more satellites is obtained at the same instance to provide an instantaneous position estimate at the time the measurements are received. For example, if measurements from only two satellites are received at a given instance, no position estimate can be calculated at that instance. The received information is still useful, but it needs to be used in combination with measurements received from the same satellite or different satellites at a different instance.

An example of using measurement signals from multiple instances is receiving two measurement signals at a first instance to and two measurement signals at a later instance t₁. If the receiver is stationary for example, these four measurement signals can be effectively considered to be received at the same position, at a single instance, as long as the difference in time between the two receive measurement signal instances is known and can therefore be compensated.

In some embodiments of the invention, a receiver position is estimated using multiple measurement signals transmitted from a single satellite at multiple instances in time over a known duration. A single satellite is typically not used for providing more than one measurement signal for estimating an instantaneous position fix unless sufficient time has elapsed for the single satellite to have moved a sufficient distance to provide a measurement signal that would be different from the first received signal from the single satellite. By determining the time intervals between multiple instances of received measurement signals, the measurements from the single satellite may be treated as if transmitted from different satellites, but at the same time. Therefore, measurement signals are received from the same satellite at multiple instances over a period of time, instead of the more conventional approach of using measurement signals of four or more satellites made at a same time. In some embodiments, the single satellite is a different single satellite at some of the multiple instances than other instances.

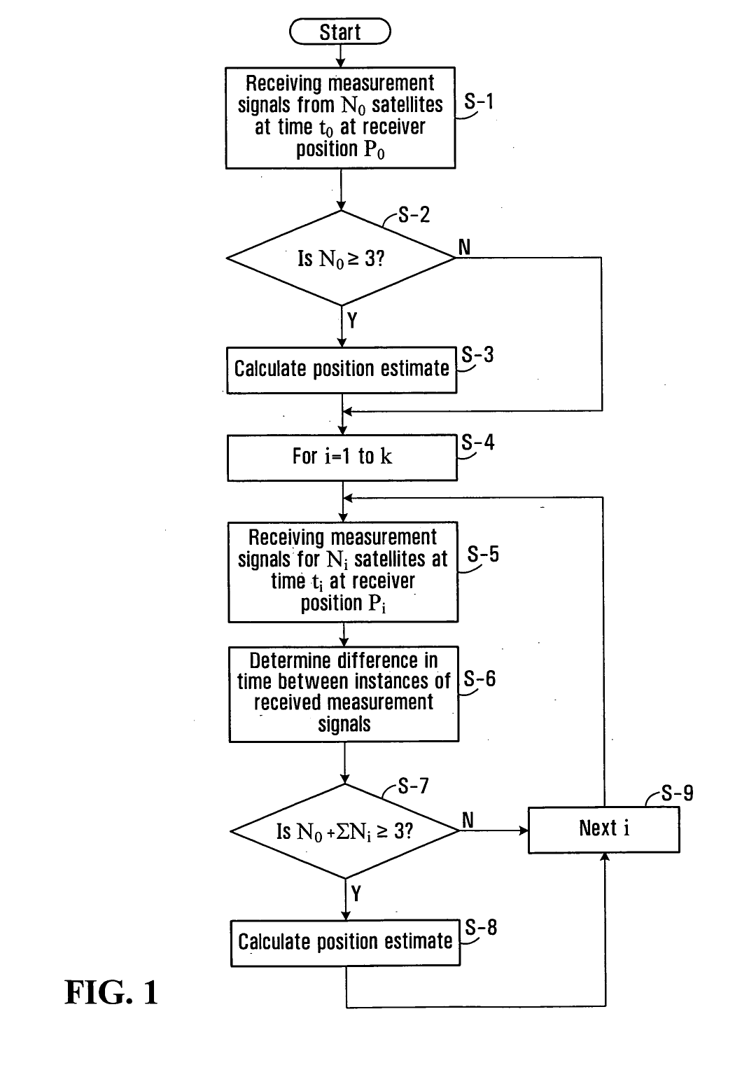

A method for estimating a position of a receiver using satellite signal data will now be described with regard to the flow chart of FIG. 1. A first step S-1 involves receiving a measurement signal from each of a respective number of satellites N₀ at a time t₀ and at a position P₀ of the receiver. A timestamp at instance to is generated from a local clock and is associated with each of the received measurement signals and is retained along with the measurements. A next step S-2 is a decision step in which it is determined if the number of satellites N₀ is greater than or equal to three. If the number of satellites N₀ is greater than or equal to three, yes path of step S-2, a position estimate is calculated at step S-3. For N₀ equal to three, a two dimensional (2D) position estimate can be determined. For N₀ greater than three, a three dimensional (3D) position estimate can be determined. After a position estimate is calculated at S-3, an iterative loop is entered for i=1 to k at step S-4. If the number of satellites N₀ is less than three, no path of step S-2, then the iterative loop is entered for i=1 to k at step S-4. For each value of i in the iterative loop, a first step S-5 involves receiving a measurement signal from each of a respective number of satellites Nᵢ at a time tᵢ and at a position Pᵢ of the receiver. A timestamp at instance tᵢ is generated from a local clock and is associated with each of the received measurement signals and is retained along with the measurements. At step S-6 the difference in the time between the current measurement tᵢ and a previous measurement tᵢ₋₁ is determined based on the time stamps associated with respective measurements. A next step S-7 is a decision step in which it is determined if a total number of satellites N₀ from step S-1 and a sum of the total number of satellites ΣNᵢ in step S-5 for all of the iterations including the current one is greater than or equal to three. If the number of satellites N₀+ΣNᵢ is greater than or equal to three, yes path of step S-7, a position estimate is calculated at step S-8. After a position estimate is calculated at step S-8, the iterative loop advances to the next value of i at step S-9. If the number of satellites N₀+ΣNᵢ is less than three, no path of step S-7, than the iterative loop advances to the next value of at step S-9. The iterative loop continues for k iterations.

In some embodiments the method may stop before k iterations are completed if the position estimate has been determined to within an acceptable error tolerance.

In some embodiments, the method may continue even after three, four, or more satellite measurements have been taken and an initial positional estimate calculation has been performed. Such additional measurements can be used to improve or refine the position estimate as will be described in further detail below.

In some embodiments the number of satellites N₀ and Nᵢ, where i=1 to k, is different at each instance t₀ and tᵢ respectively, at which signals are received. By way of example, at t₀, the number of satellites from which measurement signals are received is one. At time t₁, the number of satellites is two. The two satellites at instance t₁ may or may not include the same satellite from instance t₀. At instance t₂, the number of satellites is one. The one satellite at instance t₂ may or may not include the same satellites from instances to and/or t₁.

In some embodiments of the invention, position estimates are made for a period of time when fewer than four satellites are visible to the receiver. The situation where only a small number of satellites are visible to the receiver is a problem for satellite navigation receivers in urban, wooded, mountainous, or indoor environments. The method in general, even with a sufficient number of satellite signal measurements, will help to mitigate large position errors that arise occasionally in many conventional positioning methods.

In some embodiments, the method allows a position to be calculated for a receiver over a duration of time where no instantaneous position estimate can be calculated for a given instance within the duration.

The method may also be used with measurement signals received from two or more satellites at two or more instances, assuming ephemeris data for each satellite is known, or can be decoded by the receiver. Each measurement signal may be treated as if from a different satellite even though the same satellite may be used at different instances. For example, one satellite may provide a measurement signal at each of three different instances and the measurement signals are considered to be from an equivalent of three satellites at the same time. In some embodiments this enables a greater geometric diversity than using signals from a single satellite at multiple times.

Therefore, more generally, the method may be used to enable a position calculation from at least two satellite measurement signals received at least two instances.

In some embodiments the method is used to augment instantaneous two dimensional position estimates when only three satellites are accessible to provide three dimensional position estimates by combining the received signals from the three satellites with signal received during previous instances.

In some embodiments the method is used to augment an instantaneous position estimate for which there are four or more satellite signals. For example, when one or more of the four or more signals are noisy or attenuated, the position estimate may be prone to error. A measurement signal from a different instance can be used in combination with the four or more satellite signals of a same instance to aid in improving the instantaneous position estimate.

The accuracy of the receiver clock for the period over which the measurement signals are made is important as the accuracy will affect the position estimate of the receiver. In some embodiments it is desirable for the measurement signals to be received closely in time. In some embodiments a longer interval between two received measurement signal instances results in an improved geographical diversity of the satellite positions and a corresponding improvement in the receiver position estimate. In some embodiments position estimates are made based on a trade off between the effect of receiver clock drift and geometric diversity. Generally, an increased number of received measurement signals made in a given time duration will lead to improved accuracy in the position estimation.

In some embodiments the accuracy of the position estimate depends on clock stability and accurate knowledge of relative positional changes between measurements.

In some embodiments relative positions of the receiver are estimated for instances when measurement-signals are received. In some implementations of the invention, the receiver is assumed to be stationary or confined to a limited area of movement. Therefore, relative position changes between received measurement signals are not considered significant enough to affect the position estimate. An example of this type of situation is for a receiver positioned indoors and receiving signals from a restricted area of the sky. In such an example, P₀ in step S-1 and Pᵢ in step S-5 are the same position.

In some of the above-described embodiments, the receiver is assumed to be always stationary. However, such an assumption is not necessary. In some implementations of the invention, the receiver may be assumed to be stationary for several received measurement signals. After several position estimates have been calculated the calculated position estimates are used in determining relative position changes between instances. For example, after two position estimates are successfully made, a velocity estimate is calculated based on the successful position estimates and a determined duration between the position estimates. Using the velocity estimates, relative position changes can be calculated between a most recent instance of a received measurement signal and a current instance of a received measurement signal when the duration between the most recent and current instances is known. Performing relative position estimates based on velecity estimates may be made for example in step S-6 or in step S-8.

In some embodiments the velocity estimate is updated with each new position estimate. In some implementations the receiver is assumed to be moving with constant velocity. More generally, any model of receiver movement may be used that estimates the relative positions of the receiver at each instance measurement signals are received from one or more satellites.

In yet another implementation of the invention, information from integrated inertial sensing equipment, for example a compass, speedometer and/or a pedometer, is used to assist determining relative position changes throughout a period over which measurement signals are received at one or more instances.

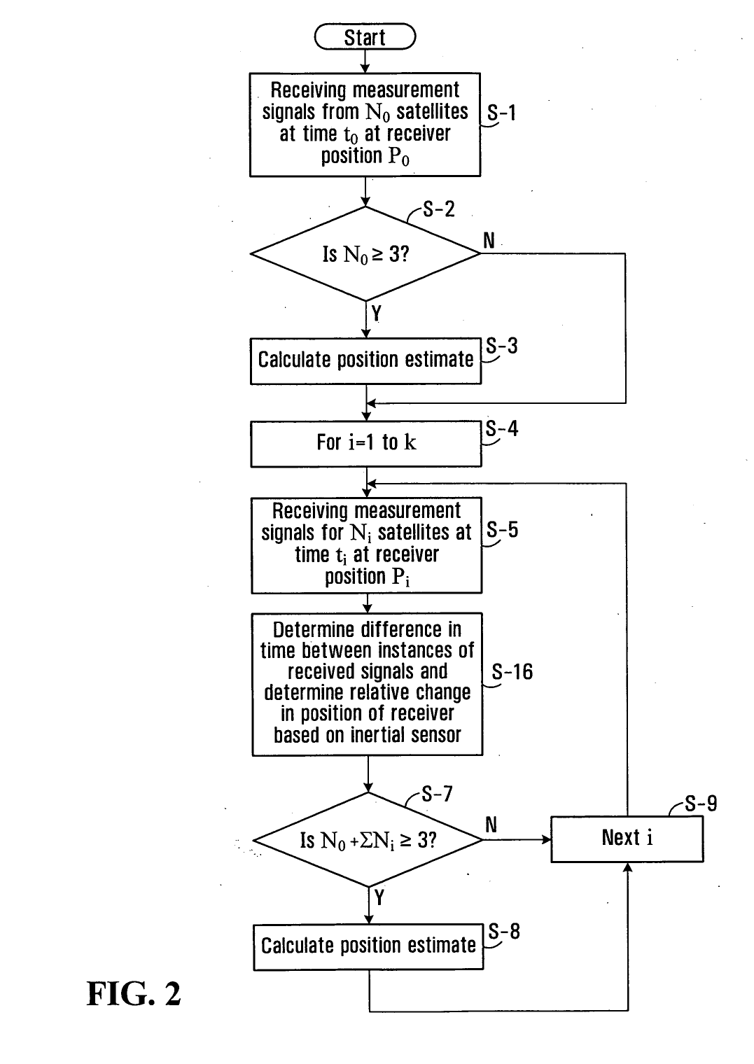

Another method for estimating a position of a receiver using satellite signal data will now be described with regard to the flow chart of FIG. 2. FIG. 2 includes many of the same steps as FIG. 1, with the exception of step S-16.

A first step S-1 involves receiving a measurement signal from each of a respective number of satellites N₀ at a time t₀ and at a position P₀ of a receiver. A timestamp at instance t₀ is generated from a local clock and is associated with each of the received measurement signals and is retained along with the measurements. A next step S-2 is a decision step in which it is determined if the number of satellites N₀ is greater than or equal to three. If the number of satellites N₀ is greater than or equal to three, yes path of step S-2, a position estimate is calculated at step S-3. For N₀ equal to three, a two dimensional (2D) position estimate can be determined. For N₀ greater than three, a three dimensional (3D) position estimate can be determined. After a position estimate is calculated at S-3, an iterative loop is entered for i=1 to k at step S-4. If the number of satellites N₀ is less than three, no path of step S-2, than the iterative loop is entered for i=1 to k at step S-4. For each value of i in the iterative loop, a first step S-5 involves receiving a measurement signal from each of a respective number of satellites Nᵢ at a time tᵢ and a at position Pᵢ of the receiver. A timestamp at instance tᵢ is generated from a local clock and is associated with each of the received measurement signals and is retained along with the measurements. At step S-16 the difference in the time between the current measurement tᵢ and a previous measurement tᵢ₋₁, is determined based on the time stamps associated with respective measurements. Also at step S-16, data from an inertial sensor is used to estimate a relative change in the position from a previous received measurement to the currently received measurement. In some embodiments, the inertial sensor may be used to determine that there has been no change in the position of the receiver between received measurements from satellites, in which case no relative change estimate of the receiver is determined before the position estimate is calculated. A next step S-7 is a decision step in which it is determined if a total number of satellites N₀ from step S-1 and a sum of the total number of satellites ΣNᵢ in step S-5 for all of the iterations including the current one is greater than or equal to three. If the number of satellites N₀+ΣNᵢ is greater than or equal to three, yes path of step S-7, a position estimate is calculated at step S-8. After a position estimate is calculated at step S-8, the iterative loop advances to the next value of i at step S-9. If the number of satellites N₀+ΣNᵢ is less than three, no path of step S-7, than the iterative loop advances to the next value of i at step S-9. The iterative loop continues for k iterations. In some embodiments the method may stop before k iterations are completed if the position estimate has been determined to within an acceptable error tolerance.

In some embodiments, the method may continue even after three, four, or more satellite measurements have been taken and a positional estimate calculation has been performed. Such additional measurements can be used to improve or refine the position estimate as will be described in further detail below.

In some embodiments the number of satellites N₀ and Nᵢ, where i=1 to k may be different at each instance, t₀ and tᵢ respectively, at which signals are received.

There may be other techniques than that described above which do not use inertial sensors to determine that the receiver has been stationary between received measurements from satellites. Use of such techniques are contemplated in the above-described method for at least determining that there has been no relative movement between received measurements.

It may not always be possible to have access to three or four satellites on a continuous basis. For example, in a forest environment there may be times when trees block a majority of the sky, and only one or two satellites may be visible at a given time. Another example may be a city canyon environment, such as a downtown core in which tall buildings limit the visibility of the sky to only a small portion at any one instance. In such an environment, position estimates between received measurement signals can be aided by the fact that shape and direction of city streets may be known to or estimated by software in the receiver and therefore knowledge of velocity information of a receiver and the time between received measurement signals provides a reasonable estimate of the change in position between received measurement signal instances. This relative change information can be used to improve the position estimate.

In a general example, two measurement signals are received, a first measurement signal at a first time tᵢ and a second measurement signal at a second time tᵢ₊₁, relative to a navigation system clock. A receiver's position Pᵢ=Pₓ, P_{y}, P_{z} at time tᵢ is unknown, but since the position Pᵢ₊₁ of the receiver (at time tᵢ₊₁) relative to Pᵢ is estimated, Pᵢ₊₁ may be expressed as Pᵢ₊₁=Pₓ+δₓ, P_{y}+δ_{y}, P_{z}+δ_{z}, where δₓ, δ_{y}, δ_{z} are estimated relative position changes, and so δₓ, δ_{y}, δ_{z} are considered to be known. A solution of a resulting set of pseudoranges involves the same number of equations with the same number of unknowns as a set for which the receiver is stationary. It will be clear to those skilled in the art, and in particular GPS algorithms, that a single-point solution may be derived from such received measurement signals using, for example, a standard, iterative, least-squares type calculation. However, this is not meant to limit the invention as other methodologies for solving simultaneous equations can be used for determining the position estimate as well.

In some embodiments the invention may be used to estimate a position directly by using at least three measurement signals received over two or more instances. In some embodiments the invention may be used to assist in a position estimate if used in combination with other data, for example, previous position estimates, data from other satellite systems, data from cellular networks or inertial data.

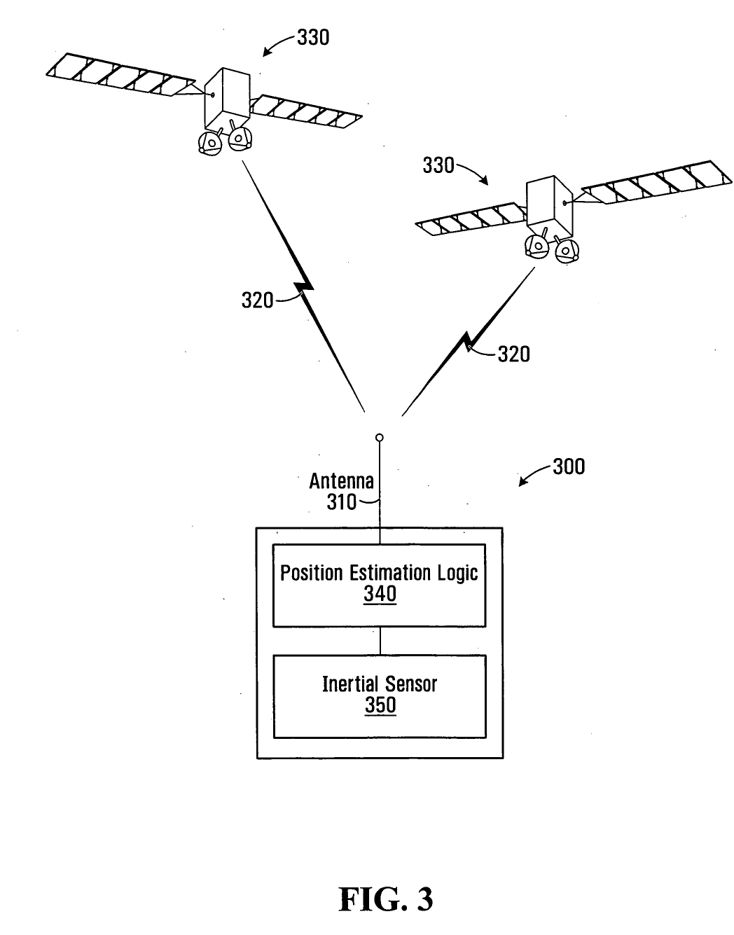

With reference to FIG. 3, an embodiment of a receiver for receiving satellite signals and determining position estimates will now be described. A receiver is generally indicated in FIG. 3 by reference number 300. The receiver 300 has an antenna 310 for receiving satellite signals 320 from satellites 330. In some embodiments, the antenna supports multiple communications systems. The receiver 300 has a position estimation logic 340 for processing the received satellite signals 320. The receiver 300 has an inertial sensor 350 for aiding in determining relative changes in position between instances of receiving satellite signals.

In some embodiments the receiver 300 includes components (not shown) found in conventional superheterodyne receiving architectures that are located between the antenna 310 and the position estimation logic 340. Examples of such components include, but are not limited to a Low Noise Amplifier (LNA), an image-rejection filter, a mixer, a Voltage Controlled Oscillator (VCO), an Intermediate Frequency (IF) filter, an analogue-to-digital converter (ADC) and a correlator.

In some embodiments, alternative receiving and frequency down converting architectures than the superheterodyne receiving architecture are contemplated.

The position estimation logic 340 calculates position estimates from the received satellite signals according to the various embodiments described above.

In some embodiments the position estimation logic 340 can be physically implemented using techniques familiar to those skilled in the field of the invention. For example, using application specific integrated circuits (ASIC) or field programmable gate arrays (FPGA) for a hardware implementation. To implement the position estimation logic 340 in software, in some embodiments a microprocessor capable of performing basic digital signal processing operations is utilized.

The receiver 300 is also shown to include inertial sensor 350 to assist in estimating changes in the relative position of the receiver throughout the measurement period. Examples of the inertial sensor 350 may include one or more of a compass, an accelerometer, a speedometer and/or a pedometer. In some implementations, the inertial sensor 350 is capable of detecting changes in orientation of the receiver 300 in one or more directions. A combination of time, speed and/or direction from the inertial sensor 350 can be used to estimate changes in the relative position of the receiver 300 from a first instance of receiving satellite positioning information to a second instance of receiving satellite positioning information.

While receiver 300 is shown to include the inertial sensor 350, it is to be understood that not all embodiments of the invention include the inertial sensor 350 as an integral part of the receiver itself. In some embodiments the receiver may have a port for accepting input of data from inertial sensing equipment via a conventional electrical-connection. For example, a portable GPS receiver may be taken in a vehicle in which the vehicle is capable of providing directional and speed information to the receiver via the port. In some embodiments, inertial sensing data could be provided to the receiver via a wireless link from inertial sensing equipment that is collocated with the receiver, to the receiver itself.

More generally, the receiver may not include inertial sensor 350 or use any form of inertial sensor information to determine relative position changes between received signal instances.

In some embodiments, receiver 300 includes a local clock for timestamping received data. In some embodiments, the clock may be calibrated via signals from satellites. In some embodiments, the clock may be calibrated via wireless communication with land based communication systems, for example cellular telecommunication systems.

In some embodiments the invention can be utilized with satellites that are part of the Navstar Global Positioning System network. In some embodiments the invention can be utilized with satellites that are part of the Galileo positioning system network. In some embodiments, the invention can be utilized with satellites that are part of the Global Navaigation Satellite System (GLONASS) network. In some embodiments, the invention can be utilized with satellites that are part of the Wide Area Augmentation System (WAAS), European Geostationary Navigation Overlay Service (EGNOS), or other systems designed to supplement a positioning system network.

In some embodiments the invention is implemented in a conventional GPS receiver such that if the receiver receives three or four measurements the receiver calculates an instantaneous position estimate, but when the receiver cannot obtain enough measurements at a given instance the receiver stores received measurements. After the receiver has received sufficient additional signals at subsequent instances, the receiver calculates a position estimate using the stored and additional received satellite signals.

In some embodiments the receiver stores received measurements with an associated timestamp and identification of the satellite the respective measurement signal was received from so that the receiver can use the received measurements at a future instance with the knowledge of whether the received measurements are from a same satellite at a different instance or a different satellite altogether.

In some embodiments the receiver includes a user interface that allows a user to determine receiver settings such as, but not limited to the duration of time between received measurements, whether a 2D position estimate is sufficient or a 3D position estimate is desired, whether only instantaneous position estimates are desired or if position estimates should consist of instantaneous position estimates or composite position estimates that are based on measurement data from multiple instances, depending on received satellite signal conditions.

Numerous modifications and variations of the present invention are possible in light of the above teachings. It is therefore to be understood that within the scope of the appended claims, the invention may be practised otherwise than as specifically described herein.

1. A method comprising:
receiving satellite positioning information at least two different instances from at least one satellite during each respective different instance; and
calculating a position estimate using the received information at the at least two different instances.

2. The method of claim 1, wherein receiving satellite positioning information at least two different instances from at least one satellite during each respective different instances comprises receiving satellite positioning information at least two different instances from more than one satellite during each respective different instance.

3. The method of claim 1, wherein receiving satellite positioning information at least two different instances from at least one satellite during each respective different instance comprises receiving satellite positioning information at least three different instances from a single satellite at each respective different time.

4. The method of claim 3, wherein the single satellite is a different single satellite at one or more of the at least two different instances.

5. The method of claim 3, wherein the single satellite is the same single satellite at each of the at least two different instances.

6. The method of claim 1, wherein receiving satellite positioning information at least two different instances from at least one satellite during each respective different instance comprises receiving satellite positioning information at more than two different instances from at least one satellite.

7. The method of claim 1, wherein calculating a position estimate using the received information at the at least two different instances further comprises determining a duration between a current instance of receiving satellite positioning information and a previous instance of receiving satellite positioning information.

8. The method of claim 1, wherein calculating a position estimate using the received information at the at least two different instances comprises calculating a two dimensional position estimate including longitude and latitude.

9. The method of claim 1, wherein calculating a position estimate using the received information at the at least two different instances comprises calculating a three dimensional position estimate including longitude, latitude and altitude.

10. The method of claim 1, wherein calculating a position estimate using the received information at the at least two different instances comprises:
receiving satellite positioning information from three satellites at one instance;
calculating a two dimensional position estimate; and
using satellite positioning information from a satellite at a different instance to augment the two dimensional position estimate to a three dimensional position estimate.

11. The method of claim 1, wherein calculating a position estimate using the received information at the at least two different instances comprises:
receiving satellite positioning information from at least four satellites at one instance;
calculating a three dimensional position estimate; and
using satellite positioning information from a satellite at a different instance to augment the three dimensional position estimate.

12. The method of claim 1 further comprising determining a relative change in position between different instances of receiving satellite positioning information using data from inertial sensors.

13. The method of claim 12, wherein using data from inertial sensors comprises using data from one or more of: a compass; an accelerometer; a speedometer; and a pedometer.

14. The method of claim 1 further comprising selecting a duration between instances that satellite positioning information is received.

15. The method of claim 1 wherein receiving satellite positioning information at least two different instances from at least one satellite comprises receiving satellite positioning information from at least one satellite, the at least one satellite being any one of: a satellite of the Global Positioning Satellite (GPS) network, a satellite of the Galileo satellite network, a satellite of the Global Navaigation Satellite System (GLONASS) network, a Wide Area Augmentation System (WAAS) enabled satellite and a European Geostationary Navigation Overlay Service (EGNOS) enabled satellite.

16. The method of claim 1 wherein a previously estimated position estimate is used in combination with received information from the at least two different instances for calculating a current position estimate.

17. A receiver for receiving satellite positioning information comprising:
an antenna for receiving satellite positioning information at least two different instances from at least one satellite during each respective different instance;
position estimation logic for calculating a position estimate using the received information at the at least two different instances.

18. The receiver of claim 17 further comprising an integrated inertial sensor.

19. The receiver of claim 17 adapted to receive inertial sensor information generated external to, but collocated with the receiver for determining a relative change in position between different instances of receiving satellite positioning information using data from inertial sensors.

20. The receiver of claim 19 wherein the integrated inertial sensor comprises one or more of a group consisting of: a compass; an accelerometer; a speedometer; and a pedometer.
